(19) United States
(12) Patent Application Publication
(10) Pub. No.: US 2025/0112422 A1
(43) Pub. Date: Apr. 3, 2025

(54) UNIVERSAL CABLE

(71) Applicant: Kramer Electronics Ltd., Airport City (IL)

(72) Inventors: Tzachi BEN DAVID, AIRPORT CITY (IL); Ehud BEJERANO, AIRPORT CITY (IL); Raanan BEN SHAHAR, AIRPORT CITY (IL); Meir FARKASH, AIRPORT CITY (IL); Ariel SEGAL, AIRPORT CITY (IL)

(21) Appl. No.: 18/828,138

(22) Filed: Sep. 9, 2024

Related U.S. Application Data
(60) Provisional application No. 63/585,979, filed on Sep. 28, 2023.

(51) Int. Cl. H01R 13/66; G06F 13/38; G06F 13/42; H01R 27/00

(52) U.S. Cl. CPC H01R 13/6691; G06F 13/382; G06F 13/4282; H01R 27/00; G06F 2213/0042

(57) ABSTRACT

Embodiments consistent with the present disclosure related to a cable connector device comprising: a host connecting side and a device connecting side; a PCB assembly connected to a USB-C male connector of the host connecting side; an HDMI male connector of the host connecting side; a USB type-A male connector of the host connecting side; and a USB-C male connector of the device connecting side.

### CROSS-REFERENCE TO RELATED APPLICATIONS

The present application claims the benefit of and priority to U.S. Provisional Application Ser. No. 63/585,979, filed on Sep. 28, 2023, the entire contents of which is incorporated herein by reference.

### FIELD OF INVENTION

The present invention relates to the field of audio, video and USB signal connectivity. More particularly, the present invention relates to a multi-use cable connector.

### BACKGROUND OF THE INVENTION

Connecting and transferring data between devices, i.e., a source device and an end unit, is quite challenging in an era with various types of interfaces and protocols. Different types of laptops support different interfaces. Some laptops support HDMI (High-Definition Multimedia Interface) which is a proprietary audio/video interface for transmitting uncompressed video data and compressed or uncompressed digital data from an HDMI-compliant source device, such as a Laptop, to a compatible monitor, video projector, digital television, or digital audio device. Other laptops support USB-C, which is a revolution in the field of video, audio and USB connectivity, as it provides in a single connector full featured connectivity that includes multi-stream video, audio, USB data and charging. Other laptops support USB Type-A that provides in a single connector video/audio connectivity and USB data.

However, video, audio and USB data stream between different interfaces can be very challenging. When someone wants to present a content from a laptop (a presentation featuring video, audio, PowerPoint files etc.) on a monitor that is not compatible with the laptop interface, it can cause much aggravation. This occurs mostly in meeting rooms where the laptop interfaces are not compatible with the monitor in the meeting room. This usually requires finding workarounds, which usually involve IT support and waste significant time from all the participants of the meeting.

Some solutions include expensive and complex box devices which support multi-interfaces and enable processing and data flow between non-compatible interfaces. These box devices are very complex and expensive and require many cables, which can be very cumbersome, Also, they require specific use and operation knowledge for their operation.

It is therefore an object of the present invention to provide a device/system for a smart, “plug & play”, cost effective connection between host and display systems.

It is a further object of the present invention to provide a device/system for the data transfer between host/stored and display systems.

Other objects and advantages of the present invention will become apparent as the description proceeds.

### SUMMARY OF THE INVENTION

The present invention relates to a cable connector device having a host side with three cable connectors—a USB-C connector, an HDMI connector and a USB type A connector. The present invention cable connector device also comprises a device/display side having a USB-C connector. The present invention enables transferring signals from the host side to the device/display side and vice versa. The signal propagation between two different connector types is carried out by a converter component (or module) which converts a signal type coming from the source connector (the source signal corresponding to the source connector type) to a signal type of the target connector (the target signal corresponding to the target connector type). The host side connectors and the device/display side connector are coupled to a PCB assembly. The converter component is implemented on the PCB assembly. A switcher component (or module) is also implemented on the PCB assembly for routing the signals propagation. The signals propagating in the present invention propagate on dedicated connection lines and all lines mentioned herein (e.g. HDMI line, USB-C line, USB type-A line) may be for example, DP lines (e.g., particularly usable for the USBC lines), USB3.X lines (e.g., particularly usable for the USBC lines and for the USB type-A lines), Transition-minimized differential signaling (TMDS) lines (e.g., particularly usable for the HDMI lines), USB2.0 lines (e.g., particularly usable for the USB type-A lines).

The present invention relates to a single cable connector device comprising:
a host connecting side and a device connecting side;
a PCB assembly connected to:
a USB-C male connector of the host connecting side;
an HDMI male connector of the host connecting side;
a USB type-A male connecter of the host connecting side; and
a USB-C male connector of the device connecting side.

According to one embodiment, the PCB comprises a switcher component and a signal converter component connected to said switcher component; wherein the switcher component is connected to the USB-C male connector of the device connecting side and to the USB-C male connector of the host connecting side; and
wherein the converter component is connected to the HDMI male connector and to the USB type-A male connecter.

According to one embodiment, the host connecting side USB-C male connector is coupled to the switcher component by means of a first USB-C line; wherein the switcher component is coupled to the device side USB-C male connector by means of a second USB-C line;
wherein the switcher component is coupled to the converter component by means of a third USB-C line;
wherein the converter component is coupled to the HDMI male connector by means of an HDMI line; and
wherein the converter component is coupled to the USB type-A male connector by means of a USB type-A line.

According to one embodiment, the switcher component is configured to provide signal propagation and connectivity between the first USB-C line and the second USB-C line;
wherein the switcher component is configured to provide signal propagation and connectivity between the second USB-C line and the third USB-C line.

According to one embodiment, the converter component is configured to:
a) convert an HDMI format signal, propagating on the HDMI line from the HDMI male connector, into a USB-C format signal to propagate on the third USB-C line;
b) convert a USB Type-A format signal, propagating on the USB type-A line from the USB Type-A male connector, into a USB-C format signal to propagate on the third USB-C line; and
c) convert a USB-C format signal, propagating on the third USB-C line from the switcher component, into a USB type-A format signal to propagate on the USB type-A line.

According to this aspect and in one embodiment, the HDMI format signal being converted in item ‘a’ comprises one or more of the following:
an AV signal;
a Display Data Channel (DDC) signal;
a CEC (Consumer Electronic Control) protocol signal; and
an HPD (Hot Plug Detect) signal.

According to one embodiment the PCB comprises a switcher component, a first signal converter component and a second signal converter component;
wherein the switcher component is connected to (A) the first signal converter component, (B) the second signal converter component, (C) the USB-C male connector of the device connecting side, (D) the HDMI male connector of the host connecting side, (E) the USB type-A male connecter of the host connecting side and to (F) the USB-C male connector of the host connecting side;
wherein the first converter component is connected to the USB-C male connector of the host connecting side; and
wherein the second converter component is connected to the USB-C male connector of the device connecting side.

According to one embodiment, the host connecting side USB-C male connector is coupled to the first converter component by means of a USB-C line; wherein the first converter component is coupled to the switcher component by means of a first HDMI line;
wherein the host connecting side USB-C male connector is coupled to the switcher component by means of a first USB3.X line;
wherein the host connecting side HDMI male connector is coupled to the switcher component by means of a second HDMI line;
wherein the host connecting side USB-A male connector is coupled to the switcher component by means of a second USB3.X line;
wherein the switcher component is coupled to the the USB-C male connector of the device connecting side by means of a third USB3.X line;
wherein the switcher component is coupled to the second converter component by means of a third HDMI line; and
wherein the second converter component is coupled to the USB-C male connector of the device connecting side by means of a DP line.

According to one embodiment, the switcher component is configured to provide signal propagation and connectivity between the first HDMI line and the third HDMI line;
wherein the switcher component is configured to provide signal propagation and connectivity between the second HDMI line and the third HDMI line;
wherein the switcher component is configured to provide signal propagation and connectivity between the first USB3.X line and the third USB3.X line; and
wherein the switcher component is configured to provide signal propagation and connectivity between the second USB3.X line and the third USB3.X line.

According to one embodiment, the first converter component is configured to:
convert a USB-C format signal, propagating on the first USB-C line from the USB-C male connector of the host connecting side into an HDMI format signal to propagate on the first HDMI line.

According to one embodiment, the second converter component is configured to:
convert an HDMI format signal, propagating on the third HDMI line from the switcher component, into a DP format signal to propagate on the DP line.

These converted signals may be, for example, an AV signal, a Display Data Channel (DDC) signal, a CEC (Consumer Electronic Control) protocol signal, an HPD (Hot Plug Detect) signal.

### BRIEF DESCRIPTION OF THE DRAWINGS

The present invention is illustrated by way of example in the accompanying drawings, in which similar references consistently indicate similar elements and in which:

FIG. 1A illustrates a non-limiting embodiment of the present invention cable connector device.

FIG. 1B illustrates a non-limiting embodiment of the present invention cable connector device.

FIGS. 2A-2E illustrate block diagrams of signal propagation possibilities according to a non-limiting embodiment of the present invention.

FIGS. 3A-3E illustrate block diagrams of signal propagation possibilities according to a non-limiting embodiment of the present invention.

### DETAILED DESCRIPTION OF THE INVENTION

The present invention relates to a single smart cable connector device. The cable device is configured to transfer data from a host side to a display side (or other type of device side) and vice versa. In some aspects, the cable uniquely provides a simple single cable replacing a plurality of devices in common use for these purposes.

The term “host side” as used herein refers to an art-recognized term, which relates, in some non-limiting aspects, to the relaying of information or signal from a source. In some embodiments, the host side, with which the present invention cable device is configured to connect, may include a variety of sources/devices, such as, for example, a laptop, a personal computer (PC), a mobile device, a smartphone, tablet etc.

The term “display side” as used herein, may be used interchangeably with the term “device side”, which terms, in turn refer to art-recognized terms, which, in some non-limiting aspects, represent the receiving end for the information or signal relayed from the “host side” source.

In some embodiments, the display and/or device side, with which the present invention cable device is configured to connect may include a variety of elements/devices, such as, for example, a monitor, a camera, a microphone, a speaker, etc., and in other embodiments, the display and/or device side may also refer to a mobile device, a smartphone, tablet, etc., including a second such device, even if the host side also makes use of a mobile device, smartphone, tablet, etc., including devices of the same model, i.e. from the same manufacturer. In some aspects, the term “display side” and/or “device side” will be understood to receive information or signal relayed from the “host side” source in any acceptable data format, including for audio and video output.

The mentioned peripherals (e.g. monitor, camera, microphone, speaker, mobile device, smartphone, tablet) may be additionally connected via a USB HUB to the present invention cable (device side).

The present invention single cable is configured to host various signals (such as Data signals, control signals, Power, etc.). The present invention host side comprises a USB-C (USB type-C) male connector interface, an HDMI (High-Definition Multimedia Interface) male connector interface and a USB 3.x type-A male connector interface (e.g. a USB A 3.2). The three connectors enable the host side to connect to a host side device which supports either one of the three connector interfaces.

The device side comprises a USB-C male connector interface.

In one embodiment of the present invention, the cable unit device supports low latency AV communication, and high resolution such as 4K@60 4:4:4 and 8K resolutions, as will be appreciated by the skilled artisan. In some aspects, the invention provides for same in an affordable configuration.

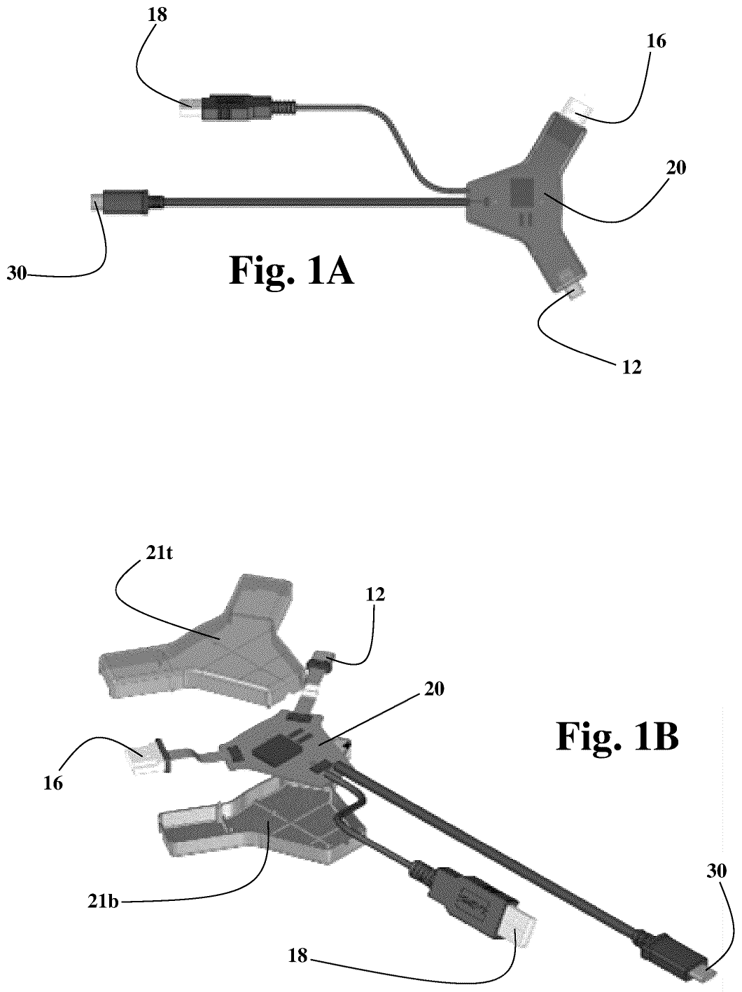

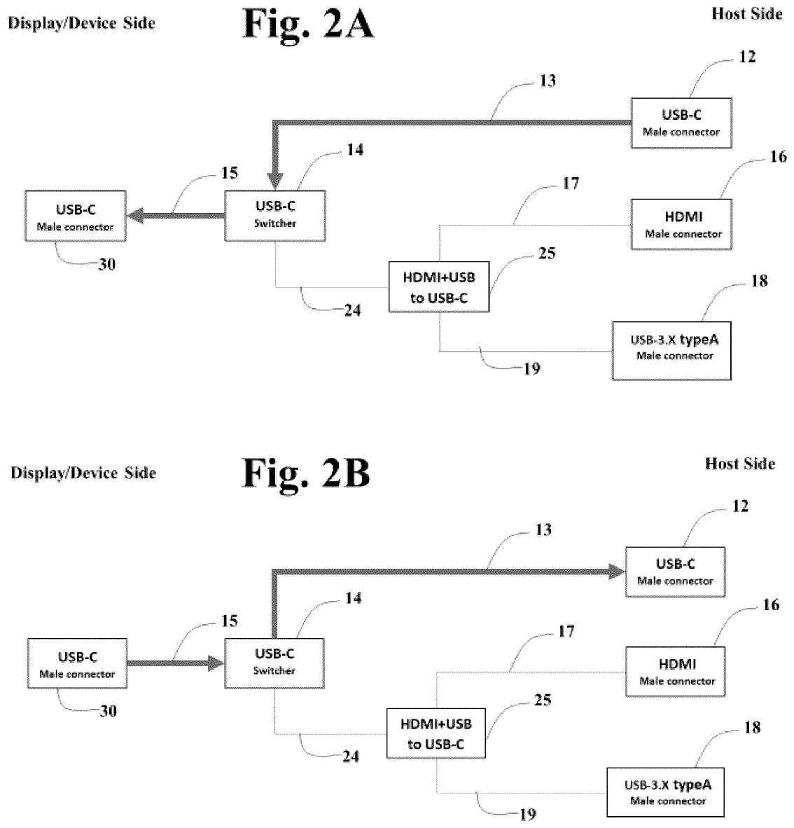

FIG. 1A shows an example of an embodiment of a cable unit 10 of the present invention. The cable unit 10 comprises a host side and a device side. The cable unit host side comprises a USB-C male connector 12 and an HDMI male connector 16 both of which are connected to a PCB assembly 20. The host side also comprises a USB type-A male connecter 18 connected to the PCB assembly 20.

The cable unit device side comprises a (second) USB-C male connector 30 also connected to the PCB assembly 20.

FIG. 1B shows an exploded view of an embodiment of the cable unit 10 with a top cover 21t and a bottom cover 21b, both of which cover the PCB assembly 20.

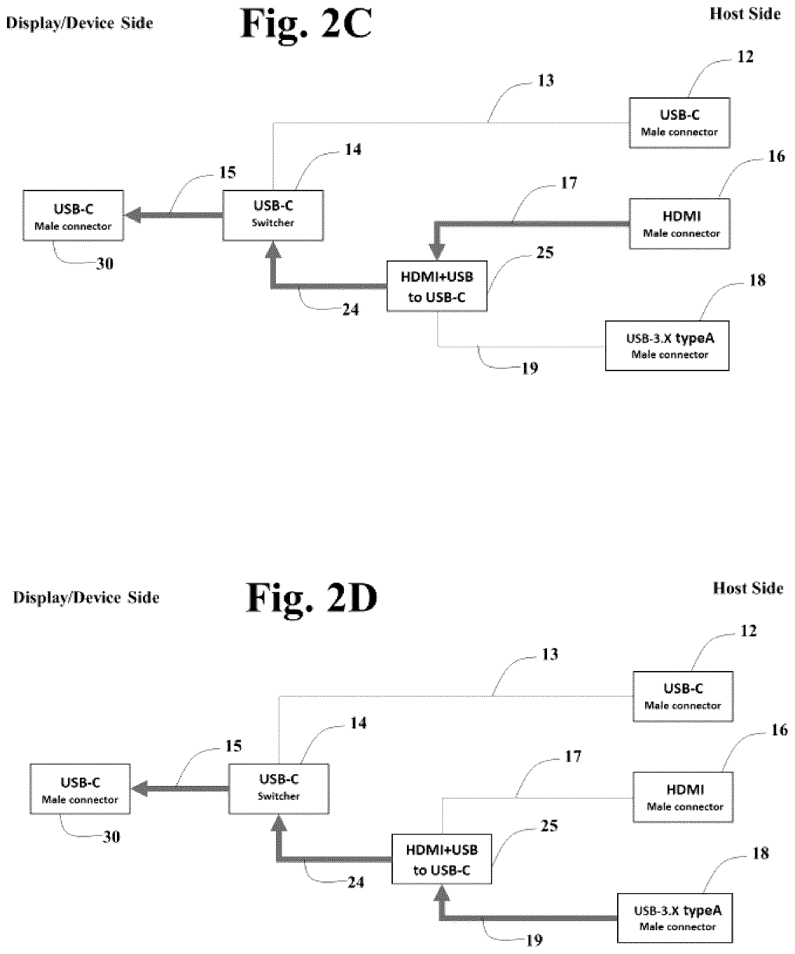

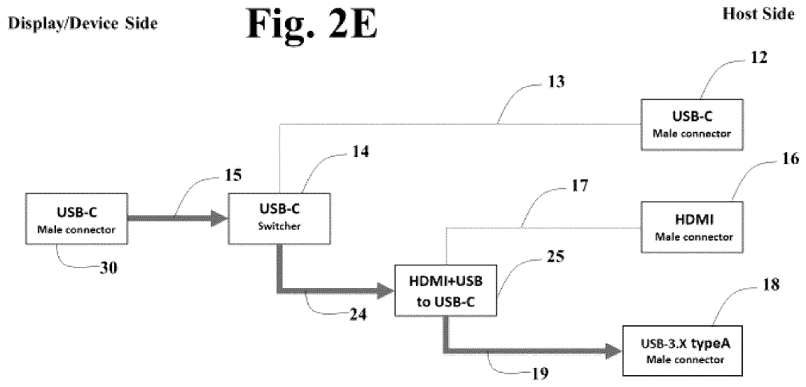

FIGS. 2A-2E show a block diagram of the signal propagation possibilities of the cable unit 10, as implemented on the PCB assembly 20, according to an embodiment of the present invention. The cable unit 10 (as shown in these figures) comprises the host side USB-C male connector 12, the HDMI male connector 16 and the USB type-A male connecter 18. The USB-C male connector 30 (of the device side) is also shown.

The host side, device side and components therebetween (e.g. switcher component, converter component) are interconnected by means of connection lines. In some aspects, reference to connection lines will include wires, fibers and the like. The connection lines as described herein, enable signal propagation therethrough.

In some aspects, the term “connection lines” is interchangeable with the term “lines”, and may refer, inter alia, to the elements for propagating a signal between the host and device side, for example, via use of wires, which represent an embodied connection line of this invention.

In some embodiments, connection lines may comprise, in non-limiting examples, USB-C lines, HDMI lines, USB type-A lines, DP lines, CC control lines, Vbus lines and the like. The present invention cable device comprise different kinds of these connection lines in a single cable, as explained herein.

The present invention further comprises a switcher component on the PCB assembly that routes the signals propagation between connection lines that are connected to the switcher component.

The host side USB-C male connector 12 is coupled to a switcher component 14 (on the PCB 20) by means of a USB-C line 13. The switcher component 14 is coupled to the device side USB-C male connector 30 by means of a USB-C line 15.

The switcher component 14 is also coupled to a converter component 25 by means of a USB-C line 24. The converter component 25 is coupled to the HDMI male connector 16 by means of an HDMI line 17. The converter component 25 is also coupled to the Type-A male connector 18 by means of a type-A line 19.

The switcher component 14 is configured in one scenario to provide signal propagation and connectivity between the lines 13 and 15 and in other scenario between lines 24 and 15. The switcher component 14 (and converter component 25) may be implemented on the PCB 20 by means of a chip set component, a MUX component, etc.

The converter component 25 is configured to convert an HDMI format signal, propagating on line 17 from the HDMI male connector interface 16, into a USB-C format signal to propagate on line 24. The converter component 25 is also configured to convert a USB Type-A format signal, propagating on line 19 from the USB Type-A male connector interface 18, into a USB-C format signal to propagate on line 24. The converter component 25 is also configured to convert a USB-C format signal, propagating on line 24 from the switcher component 14 (coming from the USB-C male connector 30), into an HDMI format signal to propagate on line 17. The converter component 25 is also configured to convert a USB-C format signal, propagating on line 24 from the switcher component 14 (coming from the USB-C male connector 30), into a USB type-A format signal to propagate on line 19.

Typically, the HDMI signal propagating on line 17 from the HDMI male connector 16 may comprise an AV signal, a Display Data Channel (DDC) signal (e.g. DDC DATA, DDC CLK (clock)), a CEC (Consumer Electronic Control) protocol signal and an HPD (Hot Plug Detect) signal (e.g. 5V). Then, the signal (e.g. comprising one or more of these signal features are converted in the converter component 25 to a corresponding USB-C signal (having the same corresponding signal features) which then propagates on line 15.

Typically, the USB signal propagating on line 24 from the switcher 14 may comprise a Display Data Channel (DDC) signal (e.g. DDC DATA, DDC CLK (clock)), a CEC (Consumer Electronic Control) protocol signal and an HPD (Hot Plug Detect) signal (e.g. 5V). Then, the signal (e.g. comprising one or more of these signal features are converted in the converter component 25 to a corresponding HDMI signal (having the same corresponding signal features) which then propagates on line 17. The switcher component 14 routes the signals propagation.

FIG. 2A shows a first signal propagation possibility, wherein a signal of USB-C format propagates from the host side USB-C male connector 12 (which receives the signal from the host device interface which is connected to USB-C male connector 12) to the switcher component 14 and then propagates to the USB-C male connector 30. This scenario is, for example, good for transferring a USB-C video signal format from the host device (e.g. laptop, PC, mobile, tablet) to target device side (e.g. monitor display).

FIG. 2B shows a second signal propagation possibility, wherein a signal of USB-C format propagates from the device side USB-C male connector 30 (which receives the signal from the device side device interface which is connected to the USB-C male connector 30) to the switcher component 14 and then propagates to the USB-C male connector 12. This scenario is, for example, good for transferring a USB-C video signal format from the device side device (e.g. a camera) to target host side (e.g. laptop).

FIG. 2C shows a third signal propagation possibility, wherein a signal of HDMI format propagates from the host side HDMI male connector 16 (which receives the signal from the host device interface which is connected to the HDMI male connector 16) to the converter component 25, converted to a corresponding USB-C signal (HDMI□USB-C) and then propagates to the switcher component 14 and then propagates to the USB-C male connector 30. This scenario is, for example, good for transferring an HDMI video signal format from the host device (e.g. laptop, PC, mobile, tablet) to target device side (e.g. monitor display).

FIG. 2D shows a forth signal propagation possibility, wherein a signal of USB type-A format propagates from the host side USB type-A male connector 18 (which receives the signal from the host device interface which is connected to the USB type-A male connector 18) to the converter component 25, converted to a corresponding USB-C signal (USB-3.X□USB-C) and then propagates to the switcher component 14 and then propagates to the USB-C male connector 30. This scenario is, for example, good for transferring data and control commands from host (laptop) to a camera which is on the device side. Control commands like power ON/OFF, etc.

FIG. 2E shows a fifth signal propagation possibility, wherein a signal of USB-C format propagates from the device side USB-C male connector 30 (which receives the signal from the device side device interface which is connected to the USB-C male connector 30) to the switcher component 14 and then propagates to the converter component 25 converted to a corresponding USB type-A format signal (USB-C□USB-3.X) and then propagates to the USB type-A male connector 18. This scenario is, for example, good for transferring a USB-C video signal format from the device side device (e.g. a camera) to target host side USB type-A supporting device (e.g. laptop).

In the present invention device, more than one signal may propagate in parallel (e.g. once connected and detected). According to another embodiment, a default scenario of signal propagation is such that the USB-C signal of line 15 is routed to line 13. If a connection occurs from the HDMI male connector 16 or USB type-A male connector 18, line 15 will automatically be routed to line 24. Other embodiments may include other priority routes (e.g. prioritizing signal propagation from element 30 to element 12 or to element 16 or to element 18 and/or prioritizing signal propagation from element 12 or from element 16 or from element 18, etc.).

According to one embodiment, a Voltage Bus (Vbus) line (not shown) may be connected between the USB-C male connector 30 and the USB-C male connector 12, e.g., for the purpose of charging. Also, several CC (Channel Configuration) control lines (not shown) may be coupled between the host side and the device side (and possibly also between the host/device side and intervening/linking components as explained herein). For example, “command has been received” or “change protocol” control signals. The CC control lines perform a number of functions such as cable attachment and removal detection, receptacle/plug orientation detection, and current advertisement. These lines could be also used for the communications required by the Power Delivery and Alternate Mode.

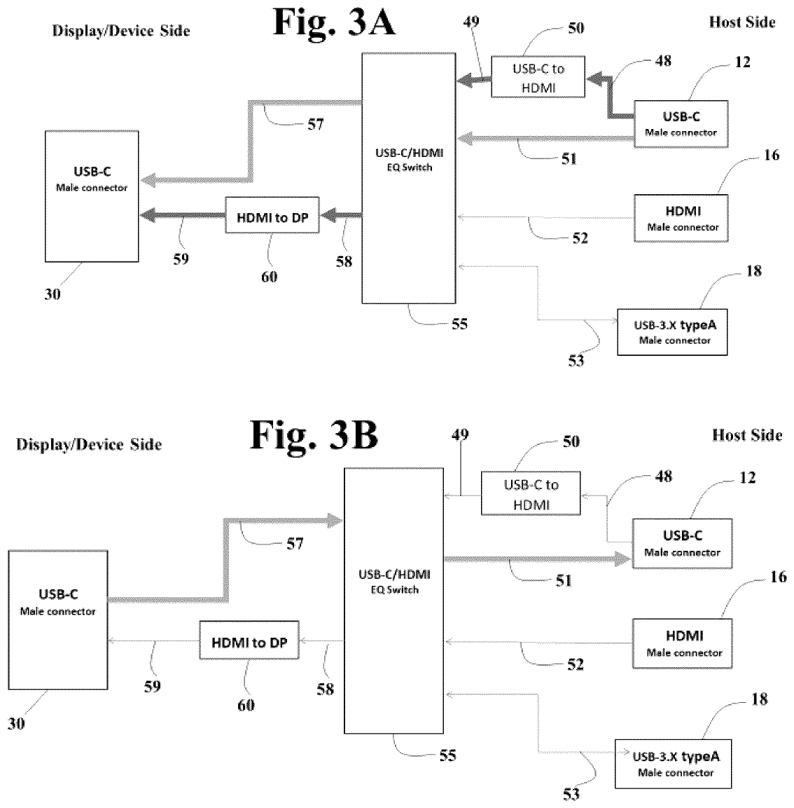

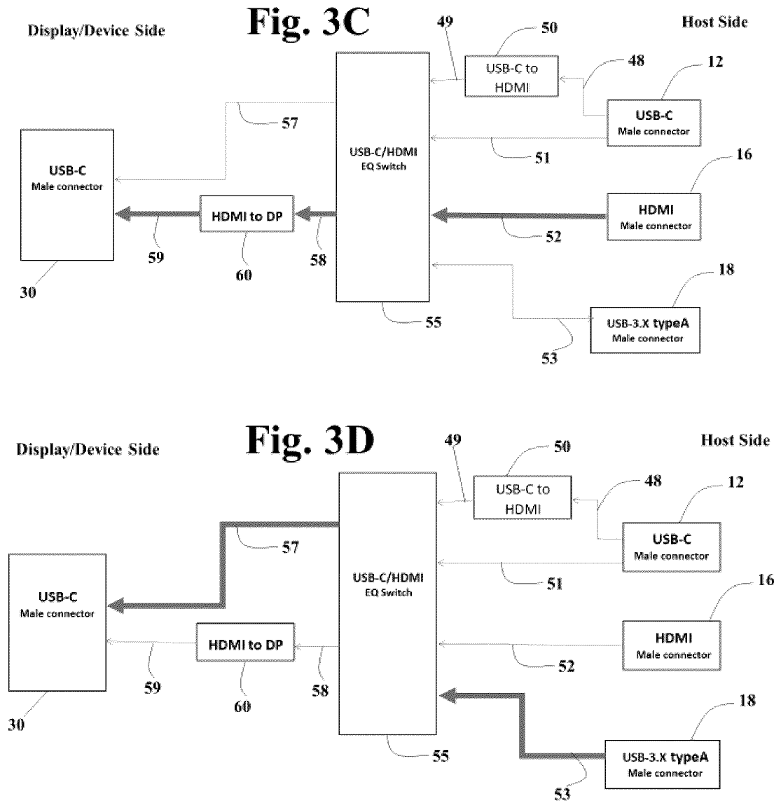

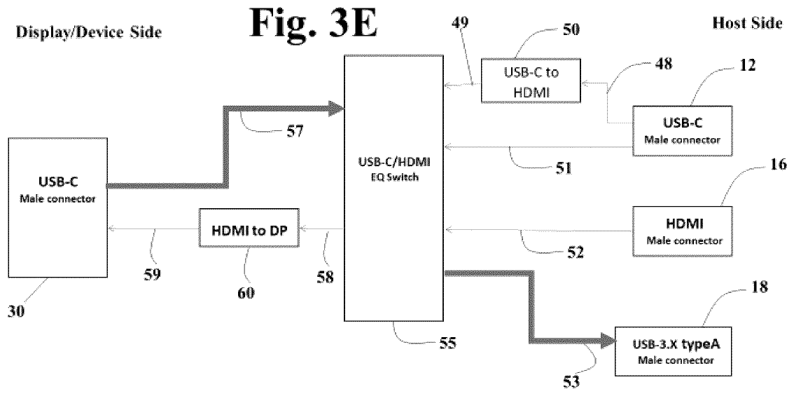

FIGS. 3A-3E show a block diagram of the signal propagation possibilities of the cable unit 10, as implemented on the PCB assembly 20, according to another embodiment of the present invention. The cable unit 10 (as shown in these figures) comprises the host side USB-C male connector 12, the HDMI male connector 16 and the USB type-A male connecter 18. The USB-C male connector 30 (of the device side) is also shown.

The host side USB-C male connector 12 is coupled to a converter component 50 (on the PCB 20) by means of a USB-C line 48. The converter component 50 is coupled to a switcher component 55 by means of a HDMI line 49.

The host side USB-C male connector 12 is also coupled to the switcher component 55 by means of a USB3.X line 51.

The switcher component 55 is coupled to the USB-C male connector 30 (of the device side) by means of a USB3.X line 57. The switcher component 55 is also coupled to a converter component 60 by means of an HDMI line 58. The converter component 60 is coupled to the USB-C male connector 30 (of the device side) by means of a DP line 59.

The HDMI male connector 16 is coupled to the switcher component 55 by means of an HDMI line 52. The Type-A male connector 18 is coupled to the switcher component 55 by means of a type-A line 53 (e.g. USB3.X line).

The switcher component 55 is configured in one scenario to provide signal propagation and connectivity between the lines 49 and 58 and in other scenario between lines 51 and 57. The switcher component 55, converter component 50 and converter component 60 may be implemented on the PCB 20 by means of a chip set component, a MUX component, etc.

The converter component 50 is configured to convert a USB-C format signal propagating on line 48 into an HDMI format signal to propagate on line 49. The converter component 60 is configured to convert an HDMI format signal propagating on line 58 into a DP format signal to propagate on line 59.

The signal types explained herein may be similar to the signal types as explained herein (e.g. with reference to FIGS. 2A-2D), mutatis mutandis, and will not be explained in detail for the sake of clarity brevity. The switcher component 55 routes the signals propagation. The Vbus and CC control lines, as explained hereinabove, may be implemented along with this embodiment of the present invention.

FIG. 3A shows a first signal propagation possibility, wherein a signal of USB-C format (e.g. audio/video signal) propagates from the host side USB-C male connector 12 (which receives the signal from the host device interface which is connected to USB-C male connector 12) to the converter component 50 via USBC line 48. For example, the signal (on line 48) may be a USB-C video signal format from the host device (e.g. laptop, PC, mobile, tablet) towards the target device side (e.g. monitor display). Then, the signal of USBC format propagates to the converter component 50, converted to a corresponding HDMI signal (USB-C□HDMI) and then propagates to the switcher component 55 (via line 49). Then the signal propagates to line 58 to the converter component 60, converted to a corresponding DP signal (HDMI□DP), and propagates to the USB-C male connector 30 (via line 59). A signal (e.g. control signal, e.g. control signal for a camera) may propagate in parallel on line 51 to the switcher component 55 and then to line 57 and to the USB-C male connector 30.

FIG. 3B shows a second signal propagation possibility, wherein a signal of USB-C format (e.g. audio/video signal) propagates from the device side USB-C male connector 30 (which receives the signal from the device side device interface which is connected to the USB-C male connector 30) to the switcher component 55 (via line 57). Then the signal propagates, to the USB-C male connector 12 (via line 51). This scenario is, for example, good for transferring a USB-C video signal format from the device side device (e.g. a camera) to target host side (e.g. laptop).

FIG. 3C shows a third signal propagation possibility, wherein a signal of HDMI format (e.g. audio/video signal) propagates from the host side HDMI male connector 16 (which receives the signal from the host device interface which is connected to the HDMI male connector 16) to the switcher component 55 (via line 52, Then the signal propagates to line 58 to the converter component 60, converted to a corresponding DP signal (HDMI□DP), and propagates to the USB-C male connector 30 (via line 59). This scenario is, for example, good for transferring an HDMI video signal format from the host device (e.g. laptop, PC, mobile, tablet) to target device side (e.g. monitor display).

FIG. 3D shows a fourth signal propagation possibility, wherein a signal of USB type-A format (e.g. audio/video signal) propagates from the host side USB type-A male connector 18 (which receives the signal from the host device interface which is connected to the USB type-A male connector 18) to the switcher component 55 (via line 53). Then the signal propagates to line 57 and propagates to the USB-C male connector 30 (via line 57).

FIG. 3E shows a fifth signal propagation possibility, wherein a signal of USB-C format (e.g. audio/video signal) propagates from the device side USB-C male connector 30 (which receives the signal from the device side device interface which is connected to the USB-C male connector 30) to the switcher component 55 (via line 57). Then the signal propagates to line 53 and propagates to the to the USB type-A male connector 18.

In the present invention device, more than one signal may propagate in parallel as explained herein, mutatis mutandis.

The cables of this invention may be manufactured by conventional means, as known in the art, which methods will comply with known standards for USB/HDMI cable production/manufacturing protocols/standards.

While some of the embodiments of the invention have been described by way of illustration, it will be apparent that the invention can be carried into practice with many modifications, variations and adaptations, and with the use of numerous equivalents or alternative solutions that are within the scope of a person skilled in the art, without departing from the spirit of the invention, or the scope of the claims.

1. A single cable connector device comprising:
a host connecting side and a device connecting side;
a PCB assembly connected to:
a USB-C male connector of the host connecting side;
an HDMI male connector of the host connecting side;
a USB type-A male connecter of the host connecting side; and
a USB-C male connector of the device connecting side.

2. The single cable connector device of claim 1, wherein the PCB comprises a switcher component and a signal converter component connected to said switcher component;
wherein the switcher component is connected to the USB-C male connector of the device connecting side and to the USB-C male connector of the host connecting side; and
wherein the converter component is connected to the HDMI male connector and to the USB type-A male connecter.

3. The single cable connector device of claim 2, wherein the host connecting side USB-C male connector is coupled to the switcher component by means of a first USB-C line;
wherein the switcher component is coupled to the device side USB-C male connector by means of a second USB-C line;
wherein the switcher component is coupled to the converter component by means of a third USB-C line;
wherein the converter component is coupled to the HDMI male connector by means of an HDMI line; and
wherein the converter component is coupled to the USB type-A male connector by means of a USB type-A line.

4. The single cable connector device of claim 3, wherein the switcher component is configured to provide signal propagation and connectivity between the first USB-C line and the second USB-C line;
wherein the switcher component is configured to provide signal propagation and connectivity between the second USB-C line and the third USB-C line.

5. The single cable connector device of claim 3, wherein the converter component is configured to:
a) convert an HDMI format signal, propagating on the HDMI line from the HDMI male connector, into a USB-C format signal to propagate on the third USB-C line;
b) convert a USB Type-A format signal, propagating on the USB type-A line from the USB Type-A male connector, into a USB-C format signal to propagate on the third USB-C line;
c) convert a USB-C format signal, propagating on the third USB-C line from the switcher component, into a USB type-A format signal to propagate on the USB type-A line.

6. The single cable connector device of claim 5, wherein the HDMI format signal being converted in item ‘a’ comprises one or more of the following:
an AV signal;
a Display Data Channel (DDC) signal;
a CEC (Consumer Electronic Control) protocol signal; and
an HPD (Hot Plug Detect) signal.

7. The single cable connector device of claim 1, wherein the PCB comprises a switcher component, a first signal converter component and a second signal converter component;
wherein the switcher component is connected to (A) the first signal converter component, (B) the second signal converter component, (C) the USB-C male connector of the device connecting side, (D) the HDMI male connector of the host connecting side, (E) the USB type-A male connecter of the host connecting side and to (F) the USB-C male connector of the host connecting side;
wherein the first converter component is connected to the USB-C male connector of the host connecting side; and
wherein the second converter component is connected to the USB-C male connector of the device connecting side.

8. The single cable connector device of claim 7, wherein the host connecting side USB-C male connector is coupled to the first converter component by means of a USB-C line;
wherein the first converter component is coupled to the switcher component by means of a first HDMI line;
wherein the host connecting side USB-C male connector is coupled to the switcher component by means of a first USB3.X line;
wherein the host connecting side HDMI male connector is coupled to the switcher component by means of a second HDMI line;
wherein the host connecting side USB-A male connector is coupled to the switcher component by means of a second USB3.X line;
wherein the switcher component is coupled to the the USB-C male connector of the device connecting side by means of a third USB3.X line;
wherein the switcher component is coupled to the second converter component by means of a third HDMI line; and
wherein the second converter component is coupled to the USB-C male connector of the device connecting side by means of a DP line.

9. The single cable connector device of claim 8, wherein the switcher component is configured to provide signal propagation and connectivity between the first HDMI line and the third HDMI line;
wherein the switcher component is configured to provide signal propagation and connectivity between the second HDMI line and the third HDMI line;
wherein the switcher component is configured to provide signal propagation and connectivity between the first USB3.X line and the third USB3.X line; and
wherein the switcher component is configured to provide signal propagation and connectivity between the second USB3.X line and the third USB3.X line.

10. The single cable connector device of claim 9, wherein the first converter component is configured to:
convert a USB-C format signal, propagating on the USB-C line from the USB-C male connector of the host connecting side into an HDMI format signal to propagate on the first HDMI line.

11. The single cable connector device of claim 9, wherein the second converter component is configured to:
convert an HDMI format signal, propagating on the third HDMI line from the switcher component, into a DP format signal to propagate on the DP line.
